(19) United States
(12) Patent Application Publication
(10) Pub. No.: US 2018/0150134 A1
(43) Pub. Date: May 31, 2018

(54) METHOD AND APPARATUS FOR PREDICTING EYE POSITION

(71) Applicant: SAMSUNG ELECTRONICS CO., LTD., Suwon-si (KR)

(72) Inventors: SEOK LEE, Hwaseong-si (KR); Dongwoo KANG, Seoul (KR); Byong Min KANG, Yongin-si (KR); DONG KYUNG NAM, Yongin-si (KR); JINGU HEO, Yongin-si (KR)

(73) Assignee: SAMSUNG ELECTRONICS CO., LTD., Suwon-si (KR)

(21) Appl. No.: 15/688,445

(22) Filed: Aug. 28, 2017

(30) Foreign Application Priority Data
Nov. 30, 2016 (KR) 10-2016-0161717

(51) Int. Cl. G06F 3/01; G06T 7/73; G06K 9/00

(52) U.S. Cl. CPC G06F 3/013; G06K 9/0061; G06K 9/00604; G06T 7/73

(57) ABSTRACT

A method and apparatus for predicting an eye position based on an eye position measured in advance are provided. In the method and apparatus, predicted eye position data may be calculated using a plurality of predictors, and one or more target predictors may be determined among the plurality of predictors based on error information of each of the plurality of predictors. Final predicted eye position data may be acquired based on predicted eye position data calculated by the determined one or more target predictors.

### CROSS-REFERENCE TO RELATED APPLICATION

This application claims priority from Korean Patent Application No. 10-2016-0161717, filed on Nov. 30, 2016, in the Korean Intellectual Property Office, the disclosure of which is incorporated herein by reference in its entirety.

### BACKGROUND

### 1. Field

Methods and apparatuses consistent with exemplary embodiments relate to a method and apparatus for predicting eye positions of a user, and more particularly, to a method and apparatus for predicting eye positions based on a plurality of eye positions that are continuous in time.

### 2. Description of the Related Art

Methods of providing a three-dimensional (3D) moving image are is broadly classified into a glasses method and a glasses-free method. In a glasses-free method of providing a 3D moving image, images for a left eye and a right may be provided to the left eye and the right eye respectively. To provide an image to each of the left eye and the right eye, positions of the left eye and the right eye may be required. In the method of providing a 3D moving image, the positions of the left eye and the right eye may be detected and a 3D moving image may be provided based on the detected positions. It may be difficult for a user to view a clear 3D moving image when the positions of the left eye and the right eye are changed during generating of a 3D moving image.

### SUMMARY

Exemplary embodiments may address at least the above problems and/or disadvantages and other disadvantages not described above. Also, the exemplary embodiments are not required to overcome the disadvantages described above, and an exemplary embodiment may not overcome any of the problems described above.

According to an aspect of an exemplary embodiment, there is provided a method of predicting an eye position of a user in a display apparatus, the method comprising receiving a plurality of pieces of eye position data that are continuous in time, calculating a plurality of predicted eye position data based on the plurality of pieces of eye position data that are continuous in time, each of the plurality of predicted eye position data calculated being using a different predictor, among a plurality of predictors; determining one or more target predictors among the plurality of predictors based on a target criterion; and acquiring final predicted eye position data based on one or more predicted eye position data calculated by the one or more target predictors among the plurality of predicted eye position data calculated using the plurality of predictors.

Each of the plurality of pieces of eye position data may be eye position data of a user calculated based on an image acquired by capturing the user.

The plurality of pieces of eye position data may be pieces of three-dimensional (3D) position data of eyes calculated based on stereoscopic images that are continuous in time.

The plurality of pieces of eye position data may be received from an inertial measurement unit (IMU).

The IMU may be included in a head-mounted display (HMD).

The target criterion may be error information and calculating of the error information may comprises: calculating, for each of the plurality of predictors, a difference between eye position data and the respective predicted eye position data that corresponds to the eye position data; and calculating the error information for each of the plurality of predictors based on the difference.

The determining of the one or more target predictors may include determining a preset number of target predictors in an ascending order of errors based on the error information.

The acquiring of the final predicted eye position data may include calculating an average value of the one or more predicted eye position data calculated by the one or more target predictors as the final predicted eye position data.

The acquiring of the final predicted eye position data may include calculating an acceleration at which eye positions change based on the plurality of pieces of eye position data, determining a weight of each of the one or more target predictors based on the acceleration, and calculating the final predicted eye position data based on the weight and the one or more predicted eye position data calculated by the one or more target predictors.

The method may further include generating a 3D image based on the final predicted eye position data. The 3D image may be displayed on a display.

The generating of the 3D image may include generating the 3D image so that the 3D image is formed in predicted eye positions of a user.

The generating of the 3D image may include, when the final predicted eye position data represents a predicted viewpoint of a user, generating the 3D image to correspond to the predicted viewpoint.

According to another aspect of an exemplary embodiment, there is provided an apparatus for predicting an eye position of a user, the apparatus comprising a memory configured to store a program to predict an eye position of a user, and a processor configured to execute the program to: receive a plurality of pieces of eye position data that are continuous in time; calculate a plurality of predicted eye position data based on the plurality of pieces of eye position data that are continuous in time, each of the plurality of predicted eye position data being calculated using a different predictor, among a plurality of predictors; determining one or more target predictors among the plurality of predictors based on a target criterion; and acquiring final predicted eye position data based on one or more predicted eye position data calculated by the one or more target predictors among the plurality of predicted eye position data calculated using the plurality of predictors. using the plurality of predictors.

The apparatus may further include a camera configured to generate an image by capturing a user. Each of the plurality of pieces of eye position data may be eye position data of the user calculated based on the image.

The apparatus may be included in an HMD.

The apparatus may further include an IMU configured to generate the plurality of pieces of eye position data.

The target criterion is error information and the processor may be further configured to execute the program to calculate the error information by: calculating, for each of the plurality of predictors, a difference between eye position data and predicted eye position data that corresponds to the eye position data; and calculating the error information for each of the plurality of predictors based on the difference.

The program may be further executed to generate a 3D image based on the final predicted eye position data. The 3D image may be displayed on a display.

According to another aspect of an exemplary embodiment, there is provided a method of predicting an eye position of a user, the method being performed by an HMD and including generating a plurality of pieces of eye position data that are continuous in time, based on information about a position of a head of a user, the information being continuous in time and being acquired by an IMU, calculating a plurality of predicted eye position data based on the plurality of pieces of eye position data that are continuous in time, each of the plurality of predicted eye position data calculated using a different predictor, among a plurality of predictors; determining one or more target predictors among the plurality of predictors based on a target criterion; and acquiring final predicted eye position data based on one or more predicted eye position data calculated by the one or more target predictors among the plurality of predicted eye position data calculated using the plurality of predictors.

### BRIEF DESCRIPTION OF THE DRAWINGS

The above and other aspects of exemplary embodiments will become apparent and more readily appreciated from the following detailed description of certain exemplary embodiments, taken in conjunction with the accompanying drawings of which:

FIG. 1 is a diagram illustrating a concept of an eye position tracking display method according to an exemplary embodiment;

FIG. 2 is a diagram illustrating a head-mounted display (HMD) according to an exemplary embodiment;

FIG. 3 is a block diagram illustrating a configuration of an eye position prediction apparatus according to an exemplary embodiment;

FIG. 4 is a flowchart illustrating an eye position prediction method according to an exemplary embodiment;

FIG. 5 is a flowchart illustrating a method of generating eye position data based on an image generated by capturing a user according to an exemplary embodiment;

FIG. 6 is a flowchart illustrating a method of generating eye position data based on an inertial measurement unit (IMU) according to an exemplary embodiment;

FIG. 7 is a diagram illustrating six axes of an IMU according to an exemplary embodiment;

FIG. 8 is a flowchart illustrating an example of calculating error information for each of a plurality of predictors in the eye position prediction method of FIG. 4 according to an exemplary embodiment;

FIG. 9 is a flowchart illustrating an example of calculating final eye position data in the eye position prediction method of FIG. 4 according to an exemplary embodiment; and

FIG. 10 is a flowchart illustrating a method of generating a 3D image according to an exemplary embodiment.

### DETAILED DESCRIPTION

Hereinafter, one or more exemplary embodiments will be described in detail with reference to the accompanying drawings. The scope of the present disclosure, however, should not be construed as limited to the exemplary embodiments set forth herein. Like reference numerals in the drawings refer to like elements throughout the present disclosure.

Various modifications may be made to the exemplary embodiments. However, it should be understood that these exemplary embodiments are not construed as limited to the illustrated forms and include all changes, equivalents or alternatives within the idea and the technical scope of this disclosure.

The terminology used herein is for the purpose of describing particular exemplary embodiments only and is not intended to be limiting of the this disclosure. As used herein, the singular forms “a,” “an” and “the” are intended to include the plural forms as well, unless the context clearly indicates otherwise. It will be further understood that the terms “include” and/or “have,” when used in this specification, specify the presence of stated features, integers, steps, operations, elements, components or combinations thereof, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which these exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of exemplary embodiments, detailed description of well-known related structures or functions will be omitted when it is deemed that such description will cause ambiguous interpretation of the present disclosure.

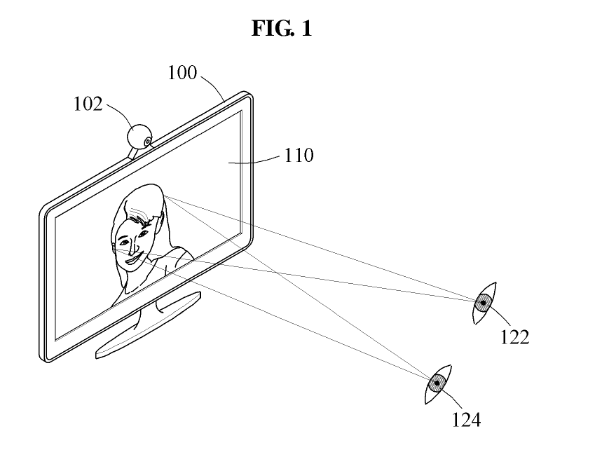

FIG. 1 is a diagram illustrating a concept of an eye position tracking display method according to an exemplary embodiment.

A display apparatus 100 may display an image 110 based on eye positions 122 and 124 of a user detected using a camera 102. According to an exemplary embodiment, eye position 122 may correspond to a right eye and eye position 124 may correspond to a left eye.

The display apparatus 100 may include, but is not limited to, for example, a tablet personal computer (PC), a monitor, a mobile phone or a three-dimensional (3D) television (TV).

For example, the display apparatus 100 may render the image 110 to be viewed in 3D at the eye positions 122 and 124. An image may include, for example, a two-dimensional (2D) image, a 2D moving image, stereoscopic images, a 3D moving image and graphics data. For example, an image may be associated with 3D, but is not limited to the 3D. Stereoscopic images may include a left image and a right image, and may be stereo images. The 3D moving image may include a plurality of frames, and each of the frames may include images corresponding to a plurality of viewpoints. The graphics data may include information about a 3D model represented in a graphics space.

When the display apparatus 100 includes a video processing device, the video processing device may render an image. The video processing device may include, for example, a graphic card, a graphics accelerator, and a video graphics array (VGA) card.

When the eye positions 122 and 124 change, a user may not view a clear 3D image because the changed eye positions 122 and 124 are not accurately reflected in a 3D moving image provided in real time. When the eye positions 122 and 124 continue to change, the display apparatus 100 may predict the eye positions 122 and 124 and may generate a 3D image so that the 3D image may appear at the predicted eye positions 122 and 124.

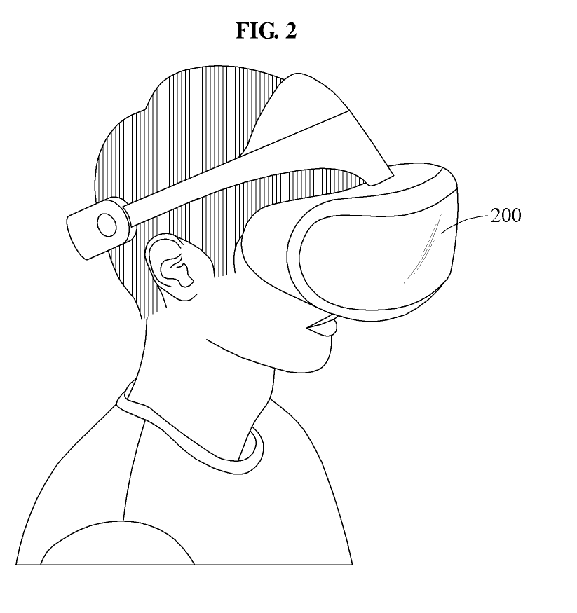

FIG. 2 is a diagram illustrating a head-mounted display (HMD) 200 according to an exemplary embodiment.

A wearable device may display a 3D image corresponding to a viewpoint of a user. For example, the wearable device may be an HMD or may have a shape of a wristwatch, or a necklace, however, the wearable device is not limited to the examples. The following description of the HMD 200 will be provided below and may be similarly applicable to other types of wearable devices.

When a user wears the HMD 200, a relative position between the HMD 200 and eye positions of the user may remain unchanged, however, a viewpoint of the user may change in response to a movement (for example, a rotation) of a head of the user. For example, when the user rotates the head from a frontal pose to a left side, an image of which a frontal viewpoint is changed to a left viewpoint in a virtual space may be displayed. When a position of the head is changed, eye positions of the user may also change. When the position of the head (that is, the eye positions) is changed, a changed viewpoint of the user may not be accurately reflected in a 3D moving image provided in real time. When the eye positions continue to change, the HMD 200 may predict the eye positions and may generate a 3D image to display a scene representing a viewpoint corresponding to the predicted eye positions.

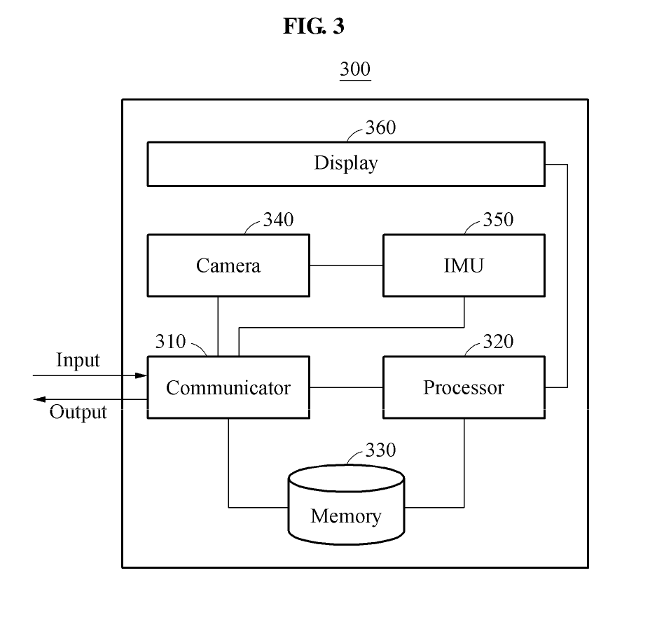

Hereinafter, a method of predicting eye positions of a user will be further described with reference to FIGS. 3 through 9.

FIG. 3 is a block diagram illustrating a configuration of an eye position prediction apparatus 300 according to an exemplary embodiment.

A display apparatus may generate a 3D image based on predicted eye positions and viewpoints. In a process of predicting an eye position and a viewpoint, a latency between an input system and an output system may occur. An error may occur between actual data and data predicted by the latency. When final predicted data is calculated based on a plurality of pieces of data predicted using a plurality of predictors, an error caused by the latency may be reduced. A method of calculating the final predicted data based on the plurality of pieces of predicted data will be further described with reference to FIGS. 3 through 9.

Referring to FIG. 3, the eye position prediction apparatus 300 includes a communicator 310, a processor 320, a memory 330, a camera 340, an inertial measurement unit (IMU) 350 and a display 360.

The eye position prediction apparatus 300 may be implemented as, for example, a system-on-chip (SOC), however, there is no limitation thereto.

In an exemplary amendment, when a relative position or relative distance between the display 360 and eye positions of a user is changed, the eye position prediction apparatus 300 may be included in the display apparatus 100 of FIG. 1.

In another exemplary amendment, when a relative position or a relative distance between the display 360 and eye positions of a user is not changed and when a position of the display 360 is changed based on a change in the eye positions, the eye position prediction apparatus 300 may be included in the HMD 200 of FIG. 2.

In yet another exemplary embodiment, when a relative position or a relative distance between the display 360 and eye positions of a user is not changed and when a position of the display 360 is changed based on a change in a head position of the user, the eye position prediction apparatus 300 may be included in the HMD 200 of FIG. 2.

The communicator 310 may be connected to the processor 320, the memory 330, the camera 340 and the IMU 350 and may transmit and receive data. Also, the communicator 310 may be connected to an external device, and may transmit and receive data.

The communicator 310 may be implemented as a circuitry in the eye position prediction apparatus 300. In an example, the communicator 310 may include an internal bus and an external bus. In another example, the communicator 310 may be an element configured to connect the eye position prediction apparatus 300 to an external device. The communicator 310 may be, for example, an interface. The communicator 310 may receive data from the external device and may transmit data to the processor 320 and the memory 330.

The processor 320 may process data received by the communicator 310 and data stored in the memory 330. The term “processor,” as used herein, may be a hardware-implemented data processing device having a circuit that is physically structured to execute desired operations. For example, the desired operations may include code or instructions included in a program. The hardware-implemented data processing device may include, but is not limited to, for example, a microprocessor, a central processing unit (CPU), a processor core, a multi-core processor, a multiprocessor, an application-specific integrated circuit (ASIC), and a field-programmable gate array (FPGA).

The processor 320 may execute a computer-readable code (for example, software) stored in a memory (for example, the memory 330), and execute instructions caused by the processor 320.

The memory 330 may store data received by the communicator 310 and data processed by the processor 320. For example, the memory 330 may store a program. The stored program may be coded to predict an eye position and may be a set of syntax executable by the processor 320.

The memory 330 may include, for example, at least one volatile memory, a nonvolatile memory, a random access memory (RAM), a flash memory, a hard disk drive and an optical disc drive.

The memory 330 may store an instruction set (for example, software) to operate the eye position prediction apparatus 300. The instruction set to operate the eye position prediction apparatus 300 may be executed by the processor 320.

The camera 340 may generate an image by capturing a scene. For example, the camera 340 may generate a user image by capturing a user.

The IMU 350 may measure a change in bearing of a device including the IMU 350. For example, when the HMD 200 is worn on a user, a position of a head of the user and a direction in which the head faces may be measured.

The display 360 may display an image generated by the processor 320. For example, stereoscopic images representing predicted eye positions may be displayed.

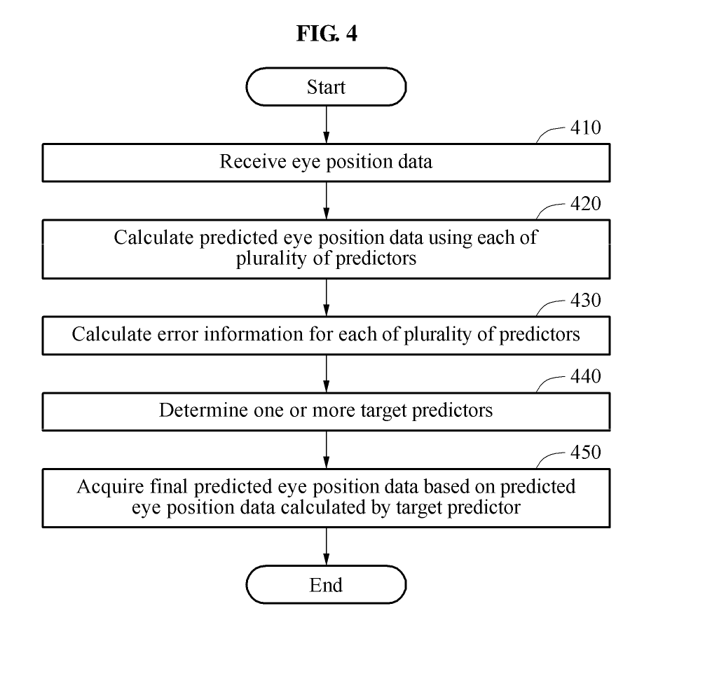

The communicator 310, the processor 320, the memory 330, the camera 340, the IMU 350 and the display 360 will be further described with reference to FIGS. 4 through 10.

FIG. 4 is a flowchart illustrating an eye position prediction method according to an exemplary embodiment.

Referring to FIG. 4, in operation 410, the processor 320 receives eye position data. The eye position data may be, for example, information about eye positions of a user of the eye position prediction apparatus 300. The eye position data may be data generated based on an actually acquired value.

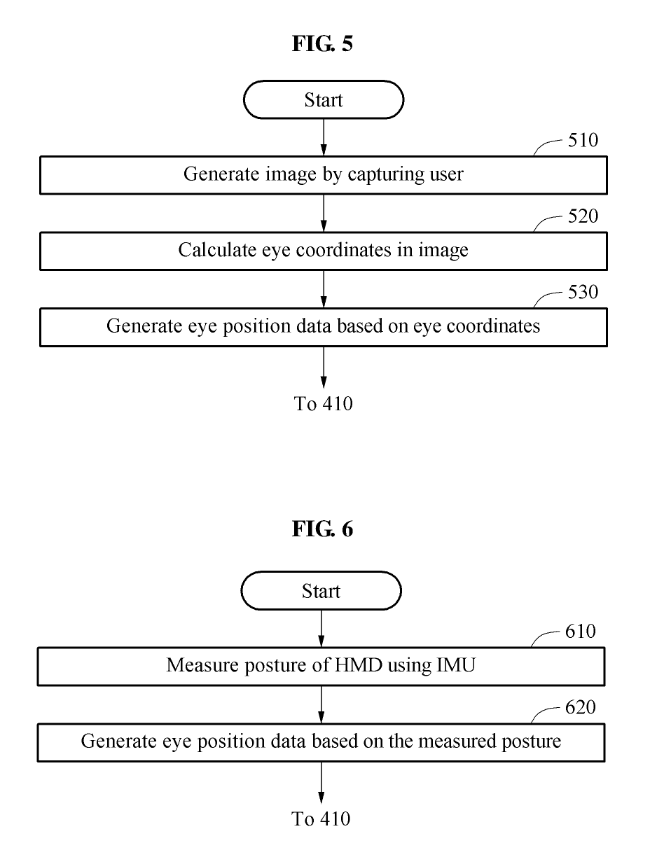

In an example, when a user watches a 3D TV, the eye position data may represent a relative position relationship between the 3D TV and eyes of the user, or absolute eye positions of the user. In an exemplary embodiment, a relative position relationship between the 3D TV and eyes of the user may be a relative distance between the 3D TV and eyes of the user. A method of generating eye position data when a user watches a 3D TV will be further described with reference to FIG. 5.

In another example, when a user wears an HMD, information about a position and direction of a head of the user may be acquired using the IMU 350. The information about the position and direction of the head may be converted to information about eye positions, and eye position data may be generated based on the information about the eye positions. A method of generating eye position data when a user wears an HMD will be further described with reference to FIG. 6.

In operation 420, the processor 320 calculates predicted eye position data using each of a plurality of predictors based on a plurality of pieces of eye position data that are continuous in time. The predicted eye position data may be calculated for each of the predictors. The calculated predicted eye position data may be 2D coordinates or 3D coordinates.

In an example, a plurality of pieces of eye position data that are continuous in time may each represent an eye position generated based on images acquired by periodically capturing a user. In another example, the plurality of pieces of eye position data may each represent a direction and a position of a head of a user that are periodically measured. The plurality of pieces of eye position data may represent a change in eye positions.

In an example, a predictor may be a data filter executed by the processor 320. The predictor may include, but is not limited to, for example, a moving average filter, a weighted average filter, a bilateral filter, a Savitzky-Golay filter and an exponential smoothing filter.

In another example, a predictor may use a neural network. The predictor may include, but is not limited to, for example, a recurrent neural network and an exponential smoothing neural network.

In an example, the plurality of pieces of eye position data may be all measured eye position data. In another example, the plurality of pieces of eye position data may have a preset window size. When new eye position data is received, an oldest eye position data may be deleted among data included in a window. When a window with a preset size is used, eye positions may be predicted by further reflecting a recent movement trend.

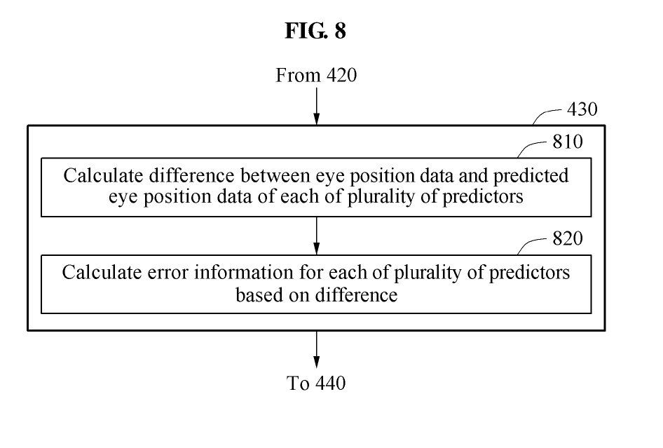

In operation 430, the processor 320 calculates error information for each of the plurality of predictors. For example, the processor 320 may calculate error information for each of the plurality of predictors based on the received eye position data. The error information may be generated based on a comparison result between actual eye position data and predicted eye position data. A method of calculating error information will be further described with reference to FIG. 8.

In operation 440, the processor 320 determines one or more predictors among the plurality of predictors based on the error information. The determined predictors may be referred to as “target predictors.” For example, the processor 320 may determine a preset number of target predictors in an ascending order of errors based on the error information of each of the plurality of predictors.

In operation 450, the processor 320 acquires final predicted eye position data based on predicted eye position data calculated by the one or more target predictors among the predicted eye position data calculated using the plurality of predictors. The final predicted eye position data may be used to generate a 3D image.

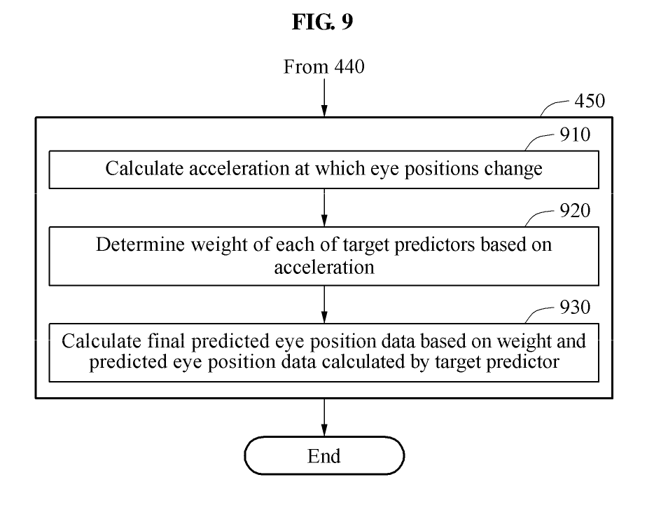

In an example, an average value of the predicted eye position data calculated by one or more target predictors may be calculated as final predicted eye position data. In another example, the final predicted eye position data may be calculated based on a weight. A method of acquiring final predicted eye position data will be further described with reference to FIG. 9.

<Method of Generating Eye Position Data by Analyzing Captured Image>

FIG. 5 is a flowchart illustrating a method of generating eye position data based on an image generated by capturing a user according to an exemplary embodiment.

Referring to FIGS. 4 and 5, operations 510, 520 and 530 may be performed before operation 410 is performed. For example, when the eye position prediction apparatus 300 of FIG. 3 is included in the display apparatus 100 of FIG. 1, operations 510 through 530 may be performed.

In operation 510, the camera 340 generates a user image by capturing a user. The camera 340 may generate a user image at preset intervals. For example, when the camera 340 operates at 60 frames per second (fps), “60” user images may be generate for one minute.

In operation 520, the processor 320 detects an eye in the user image and calculates eye coordinates of the detected eye. For example, the processor 320 may calculate coordinates of a left eye and coordinates of a right eye.

In operation 530, the processor 320 generates eye position data based on the eye coordinates. The generated eye position data may represent a 3D position. In an example, the processor 320 may calculate a distance between the camera 340 and the user based on the user image, and may generate eye position data based on the calculated distance and the eye coordinates. In another example, the processor 320 may generate eye position data based on an intrinsic parameter of the camera 340 and the eye coordinates.

<Method of Generating Eye Position Data Using IMU>

FIG. 6 is a flowchart illustrating a method of generating eye position data using an IMU according to an exemplary embodiment.

Referring to FIGS. 4 and 6, operations 610 and 620 may be performed before operation 410 is performed. For example, when the eye position prediction apparatus 300 of FIG. 3 is included in the HMD 200 of FIG. 2, operations 610 and 620 may be performed.

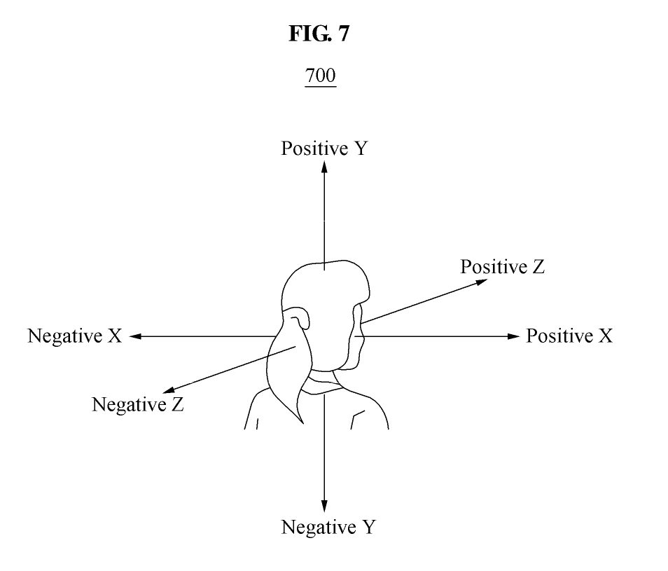

In operation 610, the IMU 350 measures a posture of the HMD 200. Because the HMD 200 moves together with a head of a user, a posture of the head may be reflected in the measured posture of the HMD 200. Also, because eye positions change in response to a movement of a position of the head, the measured posture of the HMD 200 may represent the eye positions. The measured posture may include an absolute position and a rotation state of the HMD 200. The posture of the HMD 200 will be further described with reference to FIG. 7.

In operation 620, eye position data is generated based on the measured posture. For example, the processor 320 or the IMU 350 may calculate an eye position based on the measured posture of the HMD 200. The processor 320 or the IMU 350 may generate eye position data based on the calculated eye position.

FIG. 7 is a diagram illustrating six axes of an IMU according to an exemplary embodiment.

When the HMD 200 of FIG. 2 is worn on a head of a user, the HMD 200 may measure a posture of the head. For example, the HMD 200 may measure a direction and an absolute position of the head. The HMD 200 may sense directions 700 of the six axes based on the HMD 200.

<Calculation of Error Information for Predictors>

FIG. 8 is a flowchart illustrating an example of calculating error information for each of a plurality of predictors in operation 430 of FIG. 4 according to an exemplary embodiment.

Referring to FIGS. 4 and 8, operation 430 may include operations 810 and 820.

In operation 810, the processor 320 calculates a difference between eye position data and predicted eye position data that corresponds to the eye position data and that is calculated by each of the plurality of predictors. When six predictors are provided, six differences may be calculated for the six predictors. For example, when received eye position data is t-th actual data, a first predictor may calculate a difference between t-th eye position data and t-th predicted eye position data corresponding to the t-th eye position data. The difference may be an error between an actual value and a predicted value.

In operation 820, the processor 320 calculates error information for each of the plurality of predictors based on the calculated difference.

In an example, the error information may be calculated using Equation 1 shown below. In Equation 1, e(t) denotes an error of t-th data and eᵥ(t) denotes an average of errors between “t” pieces of data. eᵥ(t) may be, for example, error information.

$${e}_{v} ( t ) = \frac{( {e}_{v} ( t - 1 ) \times ( t - 1 ) ) + e ( t )}{t} \qquad [ Equation 1 ]$$

In another example, the error information may be calculated using Equation 2 or 3 shown below. For example, to reflect a trend of a movement of an eye position, recent “K” pieces of data may be used. A window with a size of “K” may be set. In Equation 2 or 3, e_{trend}(t) may be error information.

$$\begin{matrix}{e}_{trend} ( t ) = \frac{( {e}_{trend} ( t - 1 ) \times K ) - e ( t - K ) + e ( t )}{K} & [ Equation 2 ] \\ {e}_{trend} ( t ) = \frac{{\sum }_{i = t - k}^{t} e ( i )}{K} & [ Equation 3 ]\end{matrix}$$

<Determination of Target Predictor Based on Error Information>

As described above, in operation 440 of FIG. 4, the processor 320 determines one or more target predictors among the plurality of predictors based on the error information. The processor 320 may determine a preset number of target predictors in an ascending order of errors based on the error information of each of the plurality of predictors. For example, when six predictors are provided, three target predictors may be determined in the ascending order of errors based on the error information.

<Calculation of Final Eye Position Data>

FIG. 9 is a flowchart illustrating an example of calculating final eye position data in operation 450 of FIG. 4 according to an exemplary embodiment.

Referring to FIGS. 4 and 9, operation 450 may include operations 910, 920 and 930.

In operation 910, the processor 320 calculates at least one of an acceleration or a speed at which eye positions change based on the plurality of pieces of eye position data.

In operation 920, the processor 320 determines a weight of each of the target predictors based on at least one of the acceleration or the speed that is calculated. The weight may be determined based on a characteristic of a target predictor. For example, when the processor 320 calculates a high speed and/or a high acceleration, the processor 320 may assign or determine a higher weight for a predictor that uses a neural network, in comparison to other predictors.

In operation 930, the processor 320 calculates the final predicted eye position data based on the determined weight and the predicted eye position data calculated by the target predictors. For example, the final predicted eye position data may be calculated using Equation 4 shown below. Equation 4 corresponds to an example in which a (t+3)-th eye position is predicted when three target predictors are determined and an actual eye position that is received corresponds to t-th data. In Equation 4, P_{e-final}(t+3) denotes (t+3)-th final predicted eye position data, and Pₑ₋₁(t+3), Pₑ₋₂(t+3) and Pₑ₋₃(t+3) denote predicted eye position data calculated by target predictors. Also, Wₑ₋₁(t+3), Wₑ₋₂(t+3) and Wₑ₋₃(t+3) denote weights determined for each of target predictors.

$$[ Equation 4 ]$$

$${P}_{e \text{-} final} ( t + 3 ) = \frac{( \begin{matrix}{P}_{e \text{-} 1} ( t + 3 ) \times {W}_{e \text{-} 1} ( t + 3 ) ) + \\ ( {P}_{e \text{-} 2} ( t + 3 ) \times {W}_{e \text{-} 2} ( t + 3 ) ) + ( {P}_{e \text{-} 3} ( t + 3 ) \times {W}_{e \text{-} 3} ( t + 3 )\end{matrix} )}{3}$$

<Generation of 3D Image Based on Final Eye Position Data>

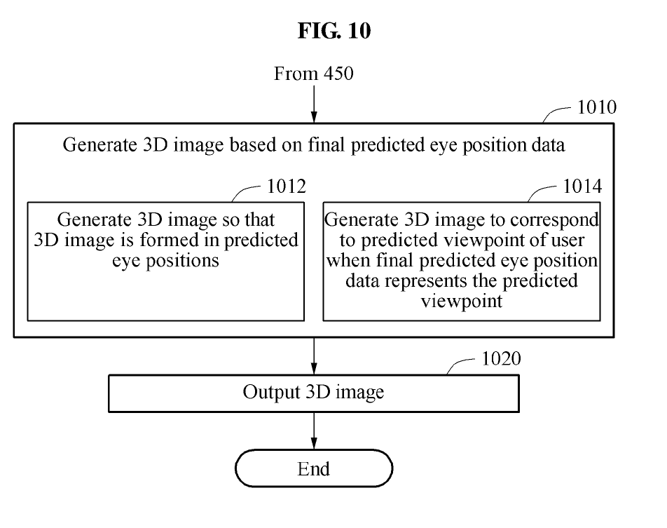

FIG. 10 is a flowchart illustrating a method of generating a 3D image according to an exemplary embodiment.

Referring to FIGS. 4 and 10, after operation 450 is performed, operations 1010 and 1020 may be additionally performed.

In operation 1010, the processor 320 generates a 3D image based on the final predicted eye position data. The processor 320 may generate a 3D image corresponding to the final predicted eye position data based on received content (for example, stereoscopic images). For example, the processor 320 may convert stereoscopic images to stereoscopic images corresponding to the final predicted eye position data, may perform pixel mapping of the converted stereoscopic images based on a characteristic of the display 360, and may generate a 3D image.

In an exemplary embodiment, operation 1010 may include operations 1012 and 1014. Operation 1012 or 1014 may be selectively performed based on a type of display apparatuses.

In an example, when a display apparatus is the display apparatus 100 of FIG. 1, operation 1012 may be performed. In operation 1012, the processor 320 generates a 3D image so that the 3D image is formed in predicted eye positions.

In another example, when a display apparatus is the HMD 200 of FIG. 2, operation 1014 may be performed. Operation 1014 may be performed when the final predicted eye position data represents a predicted viewpoint of a user. In operation 1014, the processor 320 generates a 3D image to correspond to the predicted viewpoint.

In operation 1020, the processor 320 outputs the 3D image using the display 360.

For example, the eye position prediction apparatus 300 may predict eye positions, may generate a 3D image based on the predicted eye positions, and may output the 3D image. In this example, the eye position prediction apparatus 300 may be referred to as a “display apparatus” 300. The display apparatus 300 may include, but is not limited to, for example, a tablet PC, a monitor, a mobile phone, a 3D TV and a wearable device.

The exemplary embodiments described herein may be implemented using hardware components, software components, or a combination thereof. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct the processing device to operate as desired or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described exemplary embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the exemplary embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter. The described hardware devices may be configured to act as one or more software modules in order to perform the operations of the above-described exemplary embodiments, or vice versa.

While this disclosure includes exemplary embodiments, it will be apparent to one of ordinary skill in the art that various changes in form and details may be made in these exemplary embodiments without departing from the spirit and scope of the claims and their equivalents. The exemplary embodiments described herein are to be considered in a descriptive sense only, and not for purposes of limitation. Descriptions of features or aspects in each exemplary embodiment are to be considered as being applicable to similar features or aspects in other exemplary embodiments. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of predicting an eye position of a user in a display apparatus, the method comprising:
calculating a plurality of predicted eye position data based on a plurality of pieces of eye position data that are continuous in time, each of the plurality of predicted eye position data calculated being using a different predictor, among a plurality of predictors;
determining one or more target predictors among the plurality of predictors based on a target criterion; and
acquiring final predicted eye position data based on one or more predicted eye position data calculated by the one or more target predictors among the plurality of predicted eye position data calculated using the plurality of predictors.

2. The method of claim 1, wherein each of the plurality of pieces of eye position data is eye position data of a user calculated based on an image acquired by capturing the user.

3. The method of claim 1, wherein the plurality of pieces of eye position data are pieces of three-dimensional (3D) position data of eyes calculated based on stereoscopic images that are continuous in time.

4. The method of claim 1, wherein the plurality of pieces of eye position data are received from an inertial measurement unit (IMU).

5. The method of claim 4, wherein the IMU is included in a head-mounted display (HMD).

6. The method of claim 1, wherein the target criterion is error information and calculating of the error information comprises:
calculating, for each of the plurality of predictors, a difference between eye position data and the respective predicted eye position data that corresponds to the eye position data; and
calculating the error information for each of the plurality of predictors based on the difference.

7. The method of claim 6, wherein the determining of the one or more target predictors comprises determining a preset number of target predictors in an ascending order of errors based on the error information.

8. The method of claim 1, wherein the acquiring of the final predicted eye position data comprises calculating an average value of the one or more predicted eye position data calculated by the one or more target predictors as the final predicted eye position data.

9. The method of claim 1, wherein the acquiring of the final predicted eye position data comprises:
calculating an acceleration at which eye positions change based on the plurality of pieces of eye position data;
determining a weight of each of the one or more target predictors based on the acceleration; and
calculating the final predicted eye position data based on the weight and the one or more predicted eye position data calculated by each of the one or more target predictors.

10. The method of claim 1, further comprising:
generating a 3D image based on the final predicted eye position data,
wherein the 3D image is displayed on a display.

11. The method of claim 10, wherein the generating of the 3D image comprises generating the 3D image so that the 3D image is formed in eye positions of a user predicated according the final predicted eye position data.

12. The method of claim 10, wherein the generating of the 3D image comprises, when the final predicted eye position data represents a predicted viewpoint of a user, generating the 3D image to correspond to the predicted viewpoint.

13. A non-transitory computer-readable storage medium storing a program for causing a processor to perform the method of claim 1.

14. An apparatus for predicting an eye position of a user, the apparatus comprising:
a memory configured to store a program to predict an eye position of a user; and
a processor configured to execute the program to:
calculate a plurality of predicted eye position data based on a plurality of pieces of eye position data that are continuous in time, each of the plurality of predicted eye position data being calculated using a different predictor, among a plurality of predictors;
determining one or more target predictors among the plurality of predictors based on a target criterion; and
acquiring final predicted eye position data based on one or more predicted eye position data calculated by the one or more target predictors among the plurality of predicted eye position data calculated using the plurality of predictors.

15. The apparatus of claim 14, further comprising:
a camera configured to generate an image by capturing a user,
wherein each of the plurality of pieces of eye position data is eye position data of the user calculated based on the image.

16. The apparatus of claim 14, wherein the apparatus is included in a head-mounted display (HMD).

17. The apparatus of claim 16, further comprising:
an inertial measurement unit (IMU) configured to generate the plurality of pieces of eye position data.

18. The apparatus of claim 14, wherein the target criterion is error information and the processor is further configured to execute the program to calculate the error information by: calculating, for each of the plurality of predictors, a difference between eye position data and predicted eye position data that corresponds to the eye position data; and
calculating the error information for each of the plurality of predictors based on the difference.

19. The apparatus of claim 14, wherein
the program is further executed to generate a three-dimensional (3D) image based on the final predicted eye position data, and
the 3D image is displayed on a display.

20. A method of predicting an eye position of a user, the method being performed by a head-mounted display (HMD) and comprising:
generating a plurality of pieces of eye position data that are continuous in time, based on information about a position of a head of a user, the information being continuous in time and being acquired by an inertial measurement unit (IMU);
calculating a plurality of predicted eye position data based on the plurality of pieces of eye position data that are continuous in time, each of the plurality of predicted eye position data calculated using a different predictor, among a plurality of predictors;
determining one or more target predictors among the plurality of predictors based on a target criterion; and
acquiring final predicted eye position data based on one or more predicted eye position data calculated by the one or more target predictors among the plurality of predicted eye position data calculated using the plurality of predictors.
